(19) United States
(12) Patent Application Publication
(10) Pub. No.: US 2013/0137456 A1
(43) Pub. Date: May 30, 2013

(54) SUMMIT TRACKING AND LOGGING DEVICE

(71) Applicant: Philipp Ringli, Appenzell (CH)

(72) Inventor: Philipp Ringli, Appenzell (CH)

(21) Appl. No.: 13/684,562

(22) Filed: Nov. 25, 2012

Related U.S. Application Data
(60) Provisional application No. 61/563,648, filed on Nov. 25, 2011.

(51) Int. Cl. H04W 64/00

(52) U.S. Cl. CPC H04W 64/00
USPC 455/456.1

(57) ABSTRACT

A mobile unit is disclosed for generating a summit log entry in an electronic registry of summits. The unit includes (1) a receiver that is adapted to identify a current position and/or a current time, (2) a local memory being adapted to store the current position or the current time, and (3) a transmitter being adapted to transmit a summit log entry of the mobile unit to a central unit having a summit database. The mobile unit is adapted to combine the current time and/or the current position with a reference for a summit and an identification of a user into a summit log entry. The summit log entry cannot be modified by the user, once it has been created. Similarly, the registry of summits—contained within a central unit—cannot be destroyed or stolen.

### CROSS-REFERENCE TO RELATED APPLICATIONS

This application claims priority to, and incorporates by reference, U.S. provisional patent application 61/563,648, filed Nov. 25, 2011.

### FIELD OF THE INVENTION

The field of the present invention relates to electronic registries of summits and, more particularly, to mobile units for creating summit log entries in an electronic registry of summits.

### BACKGROUND OF THE INVENTION

A summit registry is a record of visitors to a particular geographic location, which is often a summit of a mountain. These summit registries often consist of a summit book, which is enclosed in a container, such that a visitor to the summit can access the book and then log his/her name into the book upon arrival. These conventional summit logs (or summit registers) have the drawback of being exposed to severe weather conditions in the mountains and can be rendered unreadable. Furthermore, conventional summit logs can be subject to vandalism and can be stolen.

Today, Emergency Position Indicating Radio Beacons (EPIRB) are known. EPIRBs consist of small radio transmitters with which satellites or search-and-rescue-forces are able to locate persons, ships or planes in distress. First, the EPIRB determines its own position through a GPS satellite navigation system, vis-à-vis a built-in autarkic GPS receiver. After a required holding time of two to eight minutes, the EPIRB will start to send an emergency broadcast, consisting of vehicle identifier, the emergency type, the last current position with time, as well as movement direction and speed via one or more Inmarsat satellites. During the holding time, an acoustic signal is emitted to give the user an opportunity to deactivate the emergency broadcast, such that a faulty activation may be prevented.

At present, the technologies employed in EPIRBs have not been sufficiently adapted and effectively employed in the development of electronic registries of summits, nor in a mobile device that could be used in connection with such registries.

### SUMMARY OF THE INVENTION

The present invention relates to an electronic registry of summits for creating summit log entries and, more particularly, to mobile units for making a summit log entry in an electronic registry of summits. The mobile unit of the present invention generally comprises (1) a receiver, which is adapted to identify a current position of a user and/or the current time; (2) a local memory, which is adapted to save the current position and/or current time; and (3) a transmitter being adapted to transmit a summit log entry from the mobile unit to a central unit having a summit database. Such an electronic registry of summits is preferably a digital summit log. The invention provides that the mobile unit may either be a separate portable device or a part of another electronic device, which becomes a mobile unit (as described herein) by installing the necessary computer program(s) into such other electronic device to carry out the functions described herein.

An important goal of the invention is to create a type of summit book, which is not exposed to weather conditions and which cannot be destroyed or stolen. A further goal of the invention is to provide a reliable means for validating that a person, who declares to have successfully submitted a summit (e.g., in a competition), really was present at the summit. Preferably, the central unit of the electronic registry of summits will comprise its own summit database, for recording and storing summit log entries. In addition to the mobile unit, the present invention further encompasses a system for recording and maintaining an electronic registry of summits, which includes the mobile unit and central unit described herein.

The following terms (and certain terms that are similar to the following terms) shall be ascribed the meanings given to such terms below:

The term “current time” refers to the point in time at which a summit log entry was created.

The term “current position” refers to a geographic position at which the mobile unit is located during the time of the summit log entry.

The term “reference” refers to an identification of a summit for which a summit log entry is created.

The term “central unit” refers to a server, multiple servers or a data cloud that is accessible through the Internet, which can connect to the mobile unit and on which the summit log entries can be saved in a summit database.

The term “summit database” refers to any kind of database that is suited to save and output the summit log entries of a plurality of mobile units.

The term “identification” refers to an identifier with which a user can be identified non-ambiguously.

The invention provides that the mobile unit described herein, which is adapted for making a summit log entry in an electronic registry of summits, according to the invention, has the advantage that a summit log entry cannot be further modified by a user as soon as it has been created on the mobile unit. Furthermore, a registry of summits that is contained within the central unit cannot be destroyed or stolen. Additionally, the devices and methods of the present invention make it possible to accurately define the positions of summits with the help of summit log entries.

According to certain preferred aspects of the invention, the mobile unit is adapted to be particularly flat, such that the unit can be easily hidden in the clothes of a user (e.g., any kind of textile, backpack, shoe or equipment that is used for performing mountain sports). This way, a user will not be encumbered by wearing the mobile unit. More particularly, the device may preferably exhibit a planar top and bottom surface, which are bounded by four connecting sides. The mobile unit may, for example, resemble the shape and size of a typical smart phone.

According to a further aspect of the invention, the housing of the mobile unit is preferably water proof and/or airtight. The housing will preferably comprise any type of enclosure, which encapsulates the entire mobile unit (or just the local memory and other electronic portions thereof). As such, the summit log entry that is recorded by the mobile unit cannot be deleted or modified by environmental conditions. Preferably, the housing of the mobile unit is sealed in a way that prohibits access to the local memory. When the mobile unit is sealed in this manner, the summit log entries cannot be undesirably changed.

According to still further aspects of the invention, the mobile unit is designed to encode the summit log entry before saving. As used herein, the term “encoding” refers to any kind of electronic processing of data, for example, the encryption of a data packet with a code, whereby the data packet can only be decoded with the correct key (e.g., a key housed within the central unit of the summit registry). Also, the invention provides that the encoding serves the purpose that neither a user nor a third person can access the data.

According to additional aspects of the invention, the mobile unit is configured to allow a summit log entry for the same summit and/or the same user only once over a defined period of time, such as once every 12 hours. As such, a user is unable to log the same summit for fun or accidentally. In a related aspect of the invention, the local memory of the mobile unit is designed to contain at least a part of the central summit registry.

Still further, the mobile unit will preferably include a user interface display, which is adapted to display various types of information to a user. For example, the user interface display may be used to display the current time, the user's current location, distance from a summit, and/or summit log entries that are being transmitted in the vicinity of the user. This latter function enables a user to discover summits in his/her vicinity that may be worth climbing. The invention provides that no Internet connection is necessary to activate this feature, if the summit registry (or the applicable portion thereof) is saved in the local memory.

In a further aspect of the invention, the mobile unit is designed to add at least one further attribute to a summit log entry. An attribute may include, for example, any kind of additional attribute a summit log entry can be supplied with (e.g., certain information that may be particularly relevant to hikers). Furthermore, the invention provides that images can be added to the mobile unit (and display)—or the summit log entry can be personalized in other ways. In a further aspect of the invention, the mobile unit is designed to link the summit log entry with a least one other information source, such as a map. By linking with a source of geographic/map information, a summit log entry can be shown in the context of a map.

According to yet further aspects of the invention, the local memory is designed to contain a local summit database and to update the local summit database as soon as there is a data connection between the mobile unit and the central unit (and/or when the user requests a data exchange with the central unit). Through the maintenance of a local database on the mobile unit, a summit can be determined, without the mobile unit having to establish an Internet connection. In a further aspect of the invention, the mobile unit is designed to save the current position and/or current time on a mobile unit, in intervals over a given period of time, in addition to the summit log entry. This feature not only allows the summit to be logged, but also the route that the user took.

The above-described features and benefits of the present invention are described further below, in the Detailed Description of the Invention.

### BRIEF DESCRIPTION OF THE FIGURES

FIG. 1 is a schematic depiction of a digital summit registry according to a first embodiment of the present invention.

FIG. 2 is a schematic depiction of a digital summit registry according to a second embodiment of the present invention.

FIG. 3 is a schematic depiction of a digital summit registry according to a third embodiment of the present invention, from which at least one entry can be exported.

FIG. 4A-4C show different views of in the user interface display of the mobile unit.

FIG. 5A-5C show different views of the user interface display of the mobile unit, which are related to the logging of a summit.

FIG. 6 shows a view of the user interface display of the mobile unit, which relates to the settings of the mobile unit.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

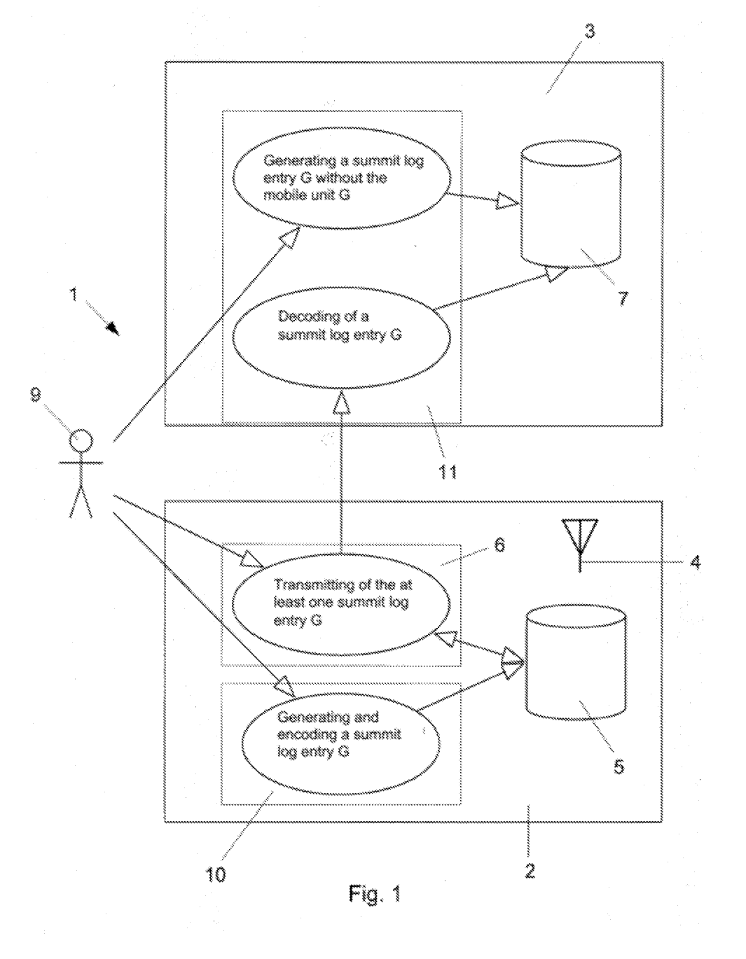

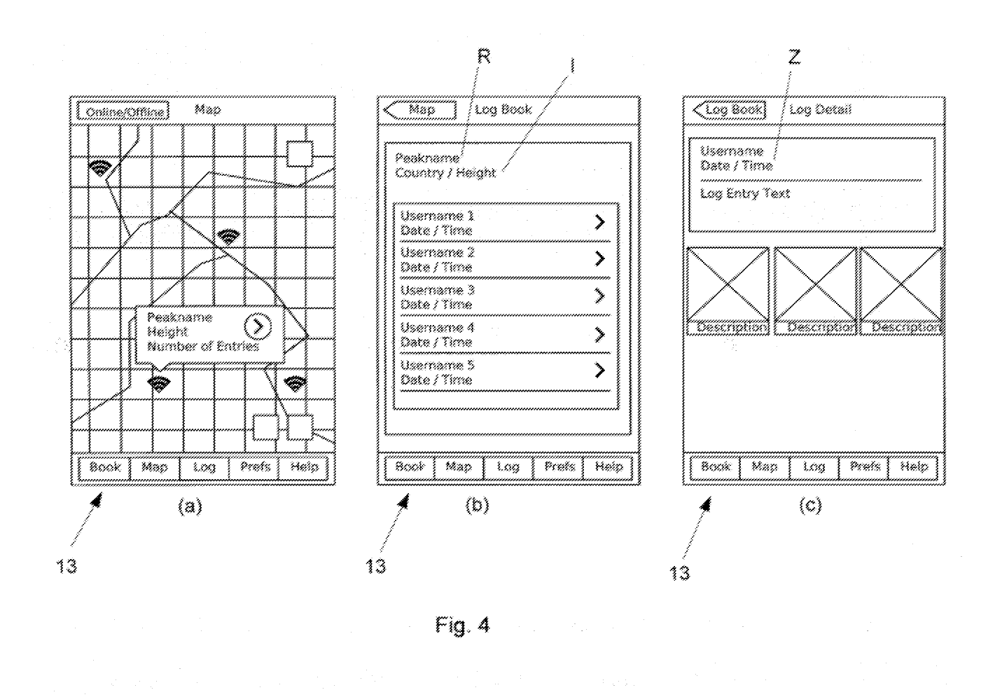

Referring now to FIGS. 1-6, a first embodiment of the invention comprises a mobile unit 2, which comprises a receiver 4, a local memory 5 and a transmitter 6. Preferably, the mobile unit 2 features a user interface display 13 (FIGS. 4-6), with which the user can operate the mobile unit 2. The user interface 13 may consist of, for example, keys and/or a touch screen that a user 9 may operate to communicate with the mobile unit 2 (and, indirectly, the central unit 3).

The mobile unit 2 may consist of a separate unit, which is preferably as small and sturdy as possible, for use everywhere in the field. In such case, the housing of the mobile unit 2 is preferably water proof and/or airtight. In a preferred embodiment, the invention provides that the housing is sealed in a way that a user 9 cannot access the internal components of the mobile unit 2 without it being noticed. In another embodiment, the elements of the mobile unit 2 are integrated in an existing electronic device, e.g., a mobile phone, a GPS receiver, a watch, a universal computer, or similar devices. In a further preferred embodiment, such an electronic device is turned into a mobile device 2, according to the invention, by installing the necessary computer program(s) into such device that will allow the device to carry out the functions described herein.

A central unit 3 according to the invention contains a least a receiver and a summit database 7. The central unit 3 preferably comprises or communicates with a server, which may be provided by an electronic summit directory service. In another embodiment, the server is a personal server of the user 9. Furthermore, a server can preferably be located in multiple locations or in a so-called cloud, i.e., decentralized on different servers that are connected via the Internet. If a user 9 reaches a summit, he logs it using the mobile unit 2. During this action, the mobile unit 2 determines the current position (P) and/or the current time (Z). The mobile unit 2 allocates a reference (R) to the current position (P) and/or current time (Z) and combines that reference (R) with the user's 9 identification, preferably the user's 9 name or alias. The current time (Z) and current position (P) will represent the time (Z) and position (P) at the time of logging the summit. This corresponds to a time stamp. The reference (R) may be allocated automatically by the mobile unit 2, or the reference (R) may be entered by the user 9. The reference (R) will represent the name of a particular summit.

This combination of current time (Z) and/or a current position (P), with a reference (R) and an identification (I) of the user 9, will define a summit log entry (G). The summit log entry (G) is encoded by the mobile unit 2. In one embodiment, such encoding step also includes an encryption procedure, such that the user 9 cannot change the summit log entry (G) and/or does not have access to it. Furthermore, the mobile unit 2 saves a summit log entry (G) in the local memory 5. If the mobile unit 2 has an Internet connection to the central unit 3—preferably via a wireless or wired data connection, including a mobile phone data connection, Wi-Fi, Bluethooth or USB—the summit log entry (G) is transmitted to the central unit 3. If there is no data connection between the mobile unit 2 and the central unit 3, the summit log entry (G) is saved only in the local memory 5, and is not transmitted to the central unit 3 until there is a sufficient data connection to transmit such information. This will not cause any modification of the summit log entry (G), and the user 9 will not have any influence over the summit log entry (G). Therefore, a summit log entry (G) of a summit can only be transmitted to the central unit 3 if the user 9 of the mobile unit 2 has actually been on the summit and has logged it, i.e., has created a summit log entry (G).

The central unit 3 will be configured to decrypt a summit entry (G), preferably using a central computing unit 11, particularly a processor, and saves the summit log entry (G) into the summit database 7. If a plurality of mobile units 2 transmit their summit log entries (G) to the summit database 7 in this manner, an empirical summit database 7 is created, in which only factually submitted summits can be saved. This summit database 7 will therefore represent the most accurate summit database 7 in the field. Furthermore, the invention provides that summit log entries (G) that have not been created with the mobile unit 2, but rather have been entered by the user 9, preferably using a computer with a data connection, can be entered into the summit database 7.

The actual position (P) and/or the actual time (Z) are determined on the mobile unit 2, preferably from the signals of a global navigation system, including GPS or Galileo. The mobile unit 2 only permits summit log entries (G), if the same summit has not been logged within a defined period of time (e.g., within the last 12 hours) by the same user 9. On the mobile unit 2, as well as in the summit database 7, more attributes (A) can be added to a summit log entry (G). Such further attributes (A) are preferably images, video and audio content, which may relate to a particular user 9 or summit.

Preferably, a summit log entry (G) can be combined with at least one more type of information, particularly the country, a lexical entry, and/or with the position in an electronic map. Preferably, the mobile unit 2 notifies the user 9 if the user 9 is in the vicinity of the position of a summit log entry (G). This can be achieved through the means of an optical, acoustic, or a tactile signal.

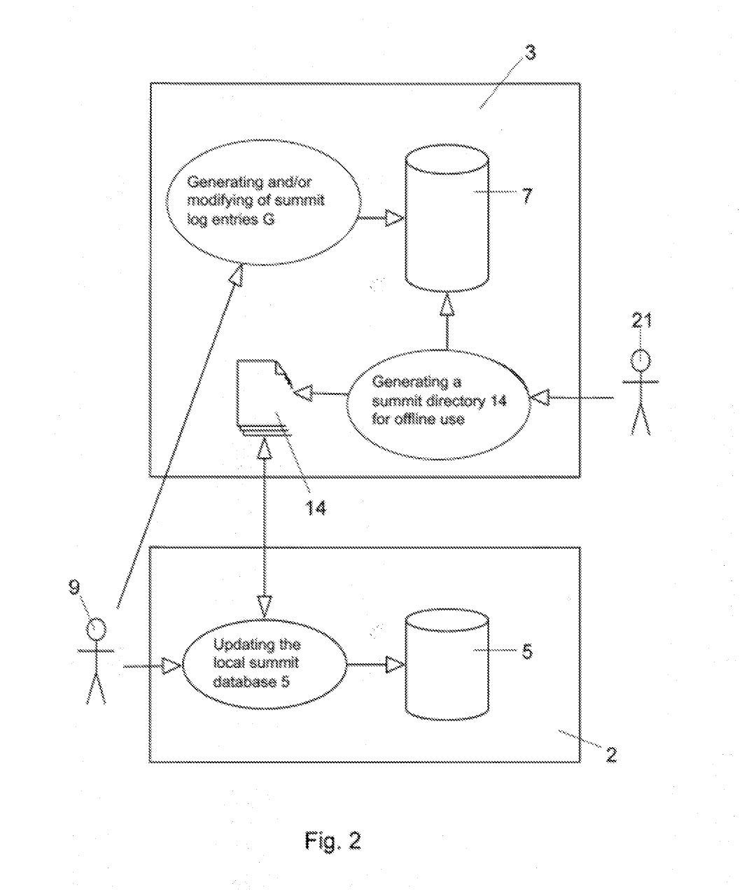

In a second preferred embodiment, and referring to FIG. 2, the central unit 3 creates either automatically or at the administrator's 21 and/or the user's 9 disposition, a summit directory for offline use. This summit directory for offline use 14 is preferably downloaded onto the mobile unit 2, if a data connection from the mobile unit 2 to the central unit 3 exists. This updated summit directory for offline use 14 is saved to the local memory 5 into a local summit directory on the mobile unit 2.

Accordingly, it is possible that a user 9 is notified if he/she is in the vicinity of the position of a summit log entry (G). Furthermore, it is preferably possible that a mobile unit 2 identifies the summit at which the user 9 is located, so that the user 9 does not have to enter a reference (R), particularly the name of the summit. This is possible because the mobile unit 2 has offline access to the summit log entries in the summit database 7 at a certain time via the summit directory for offline use 14. With the same function, it is also possible that summit log entries in the vicinity are displayed on the mobile unit's 2 display 13. This way, the user 9 has the option to ascend to these summits.

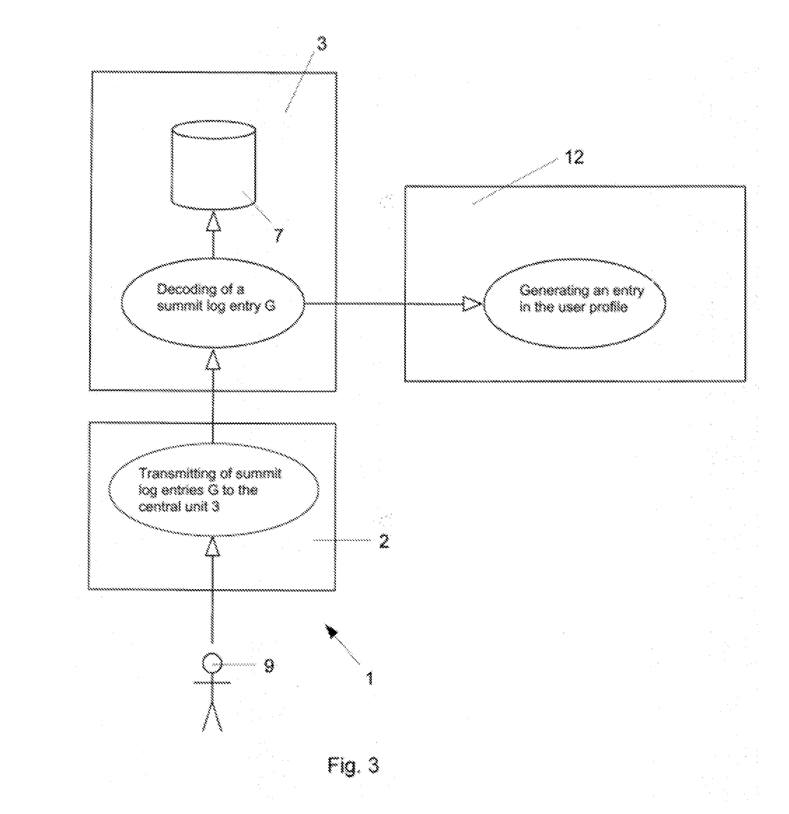

FIG. 3 shows a third preferred embodiment according to the present invention, in which the summit database is not only saved to and accessible from a central unit 3, but also an embodiment in which the summit log entries (G) of the summit database 7 can also be provided to another environment 12, particularly a social network. From this point of view, it is preferably possible that, using the central unit 3 and/or a social network 12, via the mobile unit 2 or a computer, with which a user 9 logs into the summit database 7 or the social network 12, platform-internal messages can be sent between individual users 9 or groups of users 9, also with push notification on mobile devices 2 or other portable devices.

Furthermore, it is preferably possible to create a points system among groups of users 9. Averaged calculations using height, the route difficulty, and/or the grade of difficulty of a user's summit log entry (G) can be considered. Furthermore, it is preferably possible that users 9 can follow certain other users 9 platform-internally, i.e., that they are being notified promptly, if the user 9 in question and/or his/her mobile unit 2 has made a summit log entry (G). Furthermore, it is preferably possible to initiate a search for rope teams, e.g., a general search for other users 9, using the central unit 3 and/or a social network 12. Preferably, groups (for clubs, families, and companies) can be created using the central unit 3 and/or a social network 12. Preferably, competitions, e.g., using the above-mentioned points system, can be organized using the central unit 3 and/or the social network 12. The invention provides that summit log entries (G) can preferably be rated, or commented upon, by other users 9.

Moreover, different summit lists can be created, particularly for the most difficult, the highest, etc. summits. Preferably, threads can be created using the central unit 3 and/or a social network, which are preferably supervised by moderators. Furthermore, a user 9 is preferably informed if an update of the offline summit directory has been made on the mobile unit 2.

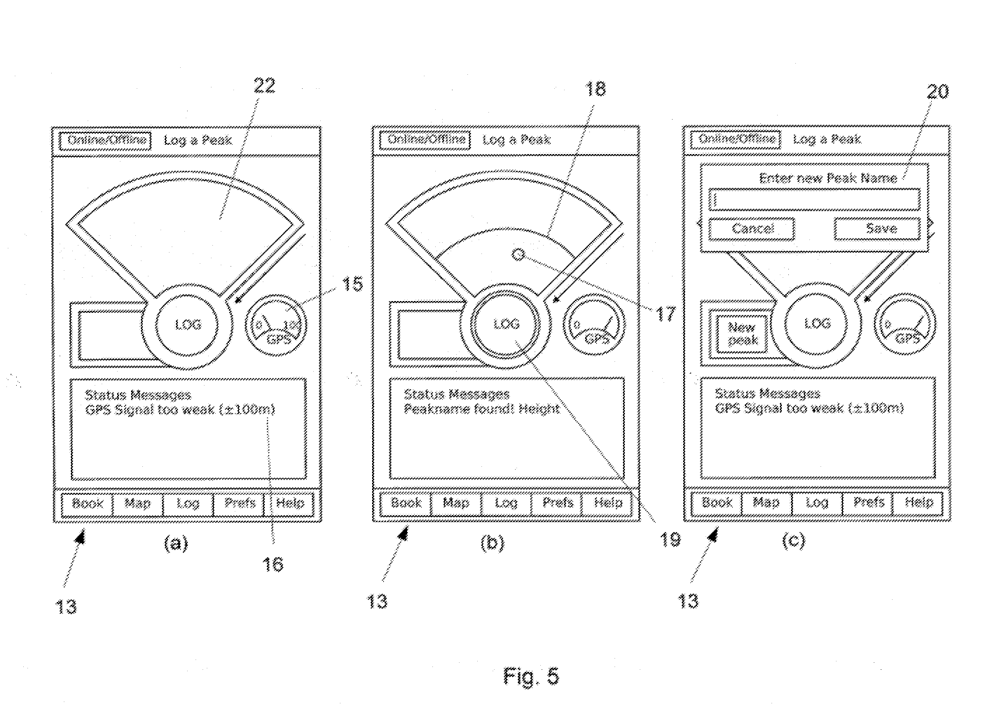

In all preferred embodiments, the user interface display 13 of the mobile unit 2 is designed to display the current position (P) and/or the current time (Z). Moreover, a compass may optionally be displayed within the user interface 13. FIG. 4 depicts several different views of the mobile unit 2. In FIG. 4A, the display shows different summits on a map. This feature may be utilized both online as well as offline. With each summit, a further view can be opened, in which the summit name, height, and/or the number of summit log entries (G) for that summit are displayed. Moreover, in this display view, there is another view that also is present in FIGS. 4B, 4C, and 5, with which the various functions of the mobile unit 13 can be accessed.

In FIG. 4B, another view is depicted that is opened by selecting a summit. In that view, the summit name, the position, as well as the height are shown. Furthermore, the list of users 9 that have ascended to the listed summit is displayed. In FIG. 4C, another preferred view of the display is shown, which is accessed by selecting a user 9, who has ascended to the corresponding summit. This view is preferably characterized by various types of information about the user and the summit log entry (G), as well as attributes (A) and/or information associated with this entry (G).

FIG. 5 shows another view of the display of the mobile unit 2. In FIG. 5A, there is no GPS signal and the mobile unit 2 notifies the user 9 that logging cannot take place. In FIG. 5B, the GPS signal is excellent, which is displayed by the hand of GPS gauge being on 100%. Furthermore, a point 17 is displayed in the vicinity radar 22, which displays summits with summit log entries (G). Using a distance line 18, the user 9 can establish the distance between himself/herself and the summit, whereby the position of the user is preferably in the center of the log button 19. In FIG. 5C, the user 9 is located on a summit and has requested a summit entry, preferably using the log button 19. In the reference field 20, the user 9 can give the summit log entry (G) a reference (R) and save the summit log entry (G). The saving of the summit log entry also triggers the transmission of the summit log entry to the central unit 3, if there is a data connection. The transmission may also be initiated manually by the user 9.

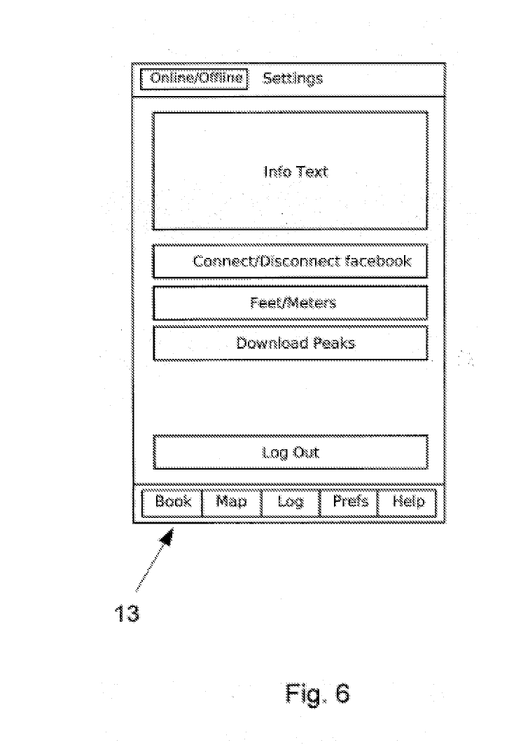

FIG. 6 depicts yet another view of the mobile unit 2 display. In that view, it is preferably possible to edit the settings of the mobile unit 2. One can connect to or disconnect from a social network 12. Preferably, the unit can be set to feet or meters, and one can download an offline summit directory 14. Moreover, one can sever the connection to the central unit 3 and/or log out of the computer program, according to the invention, and/or close the computer program, if it is installed on an electronic mobile device.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A mobile unit for generating a summit log entry in an electronic registry of summits, which comprises:
(a) a receiver that is adapted to identify a current position of a user, a current time, and a combination thereof;
(b) a local memory being adapted to store the current position and the current time of the user; and
(c) a transmitter being adapted to transmit a summit log entry of the mobile unit to a central unit having a summit database, wherein the mobile unit is adapted to combine (i) the current time or the current position with (ii) a reference variable for a summit and an identification variable of the user to create the transmitted summit log entry.

2. The mobile unit of claim 1, which is configured to identify the current position of the user through a global satellite navigation system.

3. The mobile unit of claim 2, wherein the unit is encapsulated by a sealed and waterproof housing.

4. The mobile unit of claim 3, wherein the unit is configured to encrypt the summit log entry prior to transmitting said entry to the central unit.

5. The mobile unit of claim 4, wherein the unit is configured to transmit a summit log entry for (i) a single summit, (ii) a single user, or (iii) a combination of (i) and (ii), once within a defined period of time.

6. The mobile unit of claim 5, wherein the unit further comprises a user interface display, wherein the user interface display is adapted to display the current position and the current time to the user.

7. The mobile unit of claim 6, wherein the unit and the user interface display is further configured to display summit log entries within a defined geographical area of the user.

8. The mobile unit of claim 7, wherein the unit is configured to retrieve data from the summit database via a data link with the central unit.

9. The mobile unit of claim 8, wherein the local memory of the unit is configured to store at least a part of the electronic registry of summits, which may be accessed by the unit and viewed by the user without an Internet connection.

10. The mobile unit of claim 9, wherein the unit is configured to combine each summit log entry with a map that may viewed within the user interface display.

11. The mobile unit of claim 10, wherein the unit is configured to update the electronic registry of summits stored within the local memory when (i) a data link is detected between the mobile unit and the central unit or (ii) instructed by the user.

12. The mobile unit of claim 11, which is further configured to identify a summit in the user interface display of the mobile unit, if the current position is linked to the identified summit within the summit database of the central unit.

13. The mobile unit of claim 12, wherein the unit is further configured to automatically store the current position, the current time, and the summit log entry in the local memory at set intervals over a defined period of time.

14. The mobile unit of claim 13, wherein the unit is further configured to automatically generate a summit log entry when the user has reached a summit.

15. The mobile unit of claim 13, wherein the unit is further configured to automatically generate a summit log entry when the user has reached an area within a defined radius of a summit.

16. The mobile unit of claim 13, wherein the unit is configured to automatically store the current position, the current time, and the summit log entry in the local memory every 12 hours.

17. The mobile unit of claim 4, wherein the unit is configured to transmit a summit log entry for (i) a single summit and (ii) a single user every 12 hours.

18. The mobile unit of claim 15, wherein the unit is configured as a hand held device, having a planar top and bottom side, which is adapted to be carried on a user's person.

19. The mobile unit of claim 18, wherein the unit is adapted to detect and display within the user interface display a strength of a signal for identifying the currently position.

20. The mobile unit of claim 7, wherein the unit and the user interface display is further configured to display summit log entries within a defined geographical area of a defined summit.
